(19) United States
(12) Patent Application Publication
(10) Pub. No.: US 2025/0182229 A1
(43) Pub. Date: Jun. 5, 2025

(54) SYSTEM AND METHOD FOR ARTIFICIAL INTELLIGENCE ASSISTED AND SECURE SOCIAL MEDIA BASED WILL CREATION

(71) Applicant: Shehryar J. Samson, Chalfont, PA (US)

(72) Inventor: Shehryar J. Samson, Chalfont, PA (US)

(21) Appl. No.: 19/051,938

(22) Filed: Feb. 12, 2025

Related U.S. Application Data
(63) Continuation of application No. 18/675,819, filed on May 28, 2024, now abandoned.
Application No. 18/675,819 is a continuation-in-part of application No. 18/373,414, filed on Sep. 27, 2023, now abandoned.

(51) Int. Cl. G06Q 50/18; G06N 20/00; G06Q 50/00

(52) U.S. Cl. CPC G06Q 50/186; G06N 20/00; G06Q 50/01

(57) ABSTRACT

A method for social media-based will creation includes receiving user profile information from a user, the user profile information including a domicile address. The method includes creating a social media account based on the user profile information. Creation of the social media account verifies the domicile address and the social media account comprises a graphical user interface that displays graphical representations of possession of the user that are viewable by the user and a plurality of second users selected by the user.

### CROSS-REFERENCE TO RELATED APPLICATIONS

This application is a continuation-in-part of U.S. application Ser. No. 18/373,414, filed Sep. 27, 2023, the entire contents of which are herein incorporated by reference. This application is a continuation of U.S. application Ser. No. 18/675,819 filed May 28, 2024, the entire contents of which are herein incorporated by reference.

### BACKGROUND

The present disclosure relates to the creation of a public or private will with the use of a social media-based platform to declare intentions and receive agreement from inheritors. More particularly, the present disclosure provides a social media-based platform that allows an individual to create a will by creating and maintaining an inventory of assets, advertising those assets on social media, and getting acknowledgment from those designated or wanting to inherit those assets.

Less than 33% of people that need or could benefit from having a will actually have one. There is a racial gap and socioeconomic factors that also determine the which people create and have a will. Creating a will is a difficult and time-consuming process. People do not wish to think of their own passing, and even in the event they did there are still several other impediments to the current way in which wills are created. It can be extremely difficult to deal with death, especially one's own. To compound this issue, deciding what to do with one's possessions after they pass is difficult enough, let alone attempting to decide what to do with one's own possessions while they are also contemplating their own death. Other preventing factors for not creating a will, is that there is no time to create a will; people believe they do not have enough assets to leave a will; procrastination; too expensive; don't understand; don't have time to do a full inventory of assets; have concerns that their heirs may not be able to pay the taxes or take care of their assets; an/or avoiding family conflicts.

Further, in many instances, individuals have many possessions. This means that creating a will that covers each item, or even each item having a significant value, can be an extremely time-consuming process. Further, possessions are always changing. This means that, if they create a will in 2023, the will may no longer cover their accounts, items, or other items they wish to will to family and friends in 2025.

As can be seen, there is a need for systems and methods that address the above drawbacks.

### BRIEF DESCRIPTION OF THE DRAWINGS

FIG. 1 is a diagram of a social media-based will creation system, according to aspects of the present disclosure;

FIG. 2 is a flow diagram of a method of creating a social media-based will, according to aspects of the present disclosure; and

FIG. 3 is a diagram of a graphical user interface, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

A will is in part a technical legal document. The document does not necessarily need to be covered in legal terms or definitions. However, for a will to be valid it must meet certain minimum criteria. These criteria are also different from jurisdiction to jurisdiction. For example, in one state a will may only be valid if there are two witnesses who sign the document, and in another state a will is only valid if it is notarized. This means that, in some instances, an individual may go through the process of creating a will only for it to be found invalid after it is too late, and they are deceased. Consequently, there is a need for an improvement in the art of will creation. The present disclosure substantially diverges in design elements from the known art while at the same time solving a problem many people face when needing to create a will. In this regard the present disclosure substantially fulfills these needs.

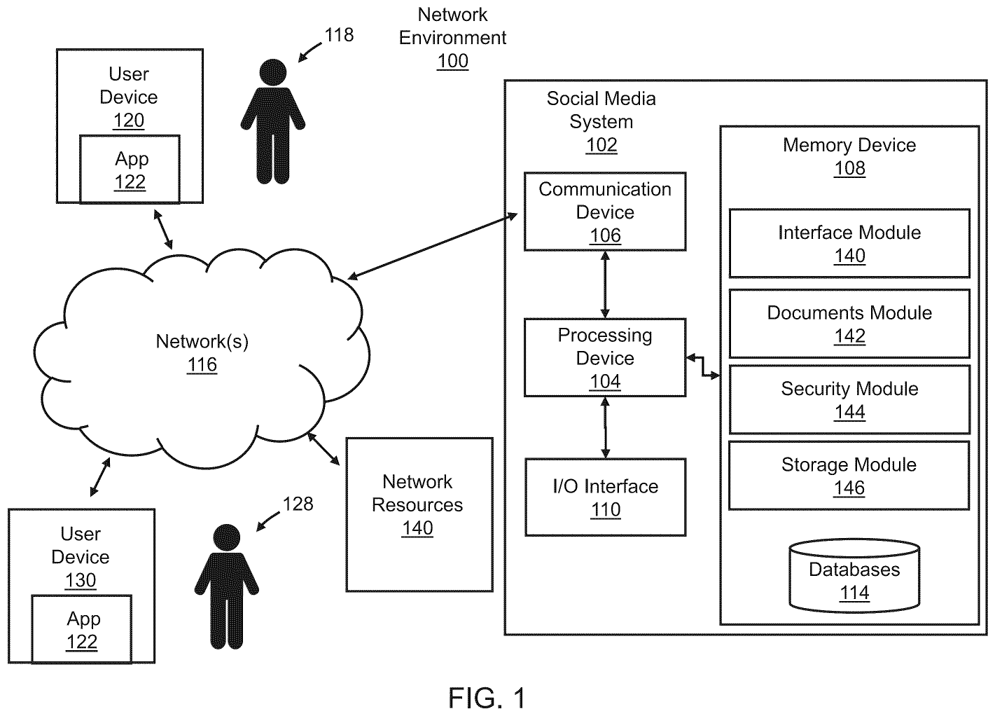

Referring now to FIG. 1, FIG. 1 illustrates a network environment including a social media system 102, according to aspects of the present disclosure. While FIG. 1 illustrates examples of components of the social media system 102, additional components can be added, and existing components can be removed and/or modified.

As illustrated in FIG. 1, the social media system 102 includes a processing device 104 coupled to a communication device 106. The processing device 104 is also coupled to a memory device 108, and an input/output (“I/O”) interface 110. In embodiments, the communication interface 106 enables the social media system 102 to communicate with other devices and systems via one or more networks 116. The social media system 102 can communicate, via the network 116, with one or more users, for example, a user 118, operating a user device 120, and a user 128, operating a user device 120. The user device 120 and/or the user device 130 can include one or more electronic devices such as a laptop computer, a desktop computer, a tablet computer, a smartphone, a thin client, and the like.

According to the aspects of the present disclosure, the user device 120 and/or the user device 130 can store and execute a copy of an application 122. The application 122 enables the user 118, operating the user device 120, and/or the user 128, operating the user device 130, to communicate with the social media system 102 to perform the processes described herein. In some embodiments, the application 122 can be a specifically designed application that operates with the social media system 102 to perform the processes and methods described herein. In some embodiments, the application 122 can be a third-party application, such as a web browser, that communicates with the social media system 102 to perform the processes and methods described herein.

To perform the process described herein, the social media system 102 can store and execute an interface module 140, a documents module 142, a security module 144, and a storage module 146 to perform the processes and methods described herein. The interface module 140, the documents module 142, the security module 144, and the storage module 144 can be stored in the memory device 108. The application 122, the interface module 140, the documents module 142, the security module 144, and the storage module 144 can include the necessary logic, instructions, and/or programming to perform the processes and methods described herein. The application 122, the interface module 140, the documents module 142, the security module 144, and the storage module 144 can be written in any programming language.

The memory device 108 can also include a database 114 that stores information and data associated with the process and methods described herein. The database 114 can store social media profiles, documents created by the system, laws and regulations of various jurisdictions, etc. The database 114 can be any type of database, for example, a hierarchical database, a network database, an object-oriented database, a relational database, a non-relational database, an operational database, and the like.

The interface module 140 operates to generate and provide graphical user interfaces (GUIs) to the application 122, for example, menus, widgets, text, images, fields, etc. Additionally, the interface module 140 can provide data to the application 122, and the application 122 can generate GUIs. The GUIs generated by the interface module 140 and/or the application 122 can be interactive. For example, the GUIs can allow the user 118 of the user devices 120 to interact with the social media system 102 to create a social media profile, to generate one or more wills, to share the one or more wills on with other users, assign assets to the will, and other processes described herein.

The documents module 142, in concert with the other modules, operates to generate one or more electronic wills (“Electronic Will”) and associate assets with the Electronic Will. The documents module 142 includes one or more machine learning algorithms that implement an AI-Enhanced continuous improvement cycle for Electronic Will creation with local human expert feedback entered back into technology platform through a social networking site in a global multilingual environment, which provides an innovative approach to user engagement or personalized legacy planning services that seamlessly integrates with legacy planning tools, make the process more efficient and user-friendly. The documents modules 142 implements various machine learning algorithms or artificial intelligence (AI) in a social networking media application that over time learns and analyzes the patterns of client/user needs considering cultural, religious traditions, linguistic, socioeconomic trends and other legacy desires arising from client input into the application to draft and populate an Electronic Will. The documents module 142 can then validate the Electronic Will with diverse legal framework input of local service providers in the estate planning business to be compliant in an ever changing and challenging global compliance requirements. The data and changes can be fed back by local service providers back into the platform that then goes back into the AI platform for a continuous improvement cycle to ensure accuracy and inclusivity in real-time Electronic Will creation process. The documents module 142 employs this understanding of user behaviors to adapt to future user needs and adapting to the changing legal requirements globally for the purpose of content in an electronic will, last will and testaments, and/or other wills to memorialize legacy plans.

The documents module 142 facilitates communication and acknowledgment from beneficiaries, making the Electronic Will creation process collaborative and transparent. The documents module 142 allows users to translate their wishes as a benefactor to beneficiaries in other regions or other languages. The documents module 142 and/or the interface module 140 allows users unable to read or write to speak into the AI avatar, which is able to convert their speech to text, search and give advice, and convert back to local languages. The documents module 142 can implement user customization features that specify how the Electronic Will is tailored to each user, showcasing the innovative aspects that make it distinct from generic legacy planning tools.

The documents module 142 can implement one or more Core Modules for AI-enhanced continuous improvement. The documents module 142 can implement a Behavioral Analysis and User Needs Module that include machine learning algorithms and AI techniques for analyzing user behaviors, considering cultural, religious, linguistic, and socioeconomic factors. The adaptive nature of the documents module 142 learns from client inputs to continuously refine its understanding of user needs.

The documents module 142 can implement a Global Compliance Module. The Global Compliance Module includes one or more machine learning algorithms that integrate diverse legal frameworks from local service providers in the estate planning business to ensure compliance with changing global requirements. The documents module 142 can implement a dynamic data feedback loop where changes and inputs from legal frameworks are incorporated into the platform for continuous improvement.

The documents module 142 can implement a Real-time Adaptation Module. The Real-time Adaptation Module includes one or more machine learning algorithms that are trained and learn user behaviors to adapt in real-time to future user needs and changing legal requirements globally. The documents module 142 can predict and proactively cater to evolving legacy planning trends.

The security module 144, in concert with the other modules, operates to security verify the user 118 and user 128 accessing the social media system. In embodiments, the security module 144 can utilize multi-factor authentication and verification methods to collectively enhance the security of the user profile, especially in the context of Electronic Will creation through a social networking platform. The single profile per user login using multi-factor authentication can include biometric login in social networking application after valid ID verification using the user device 120, e.g., a mobile device with camera and/or phone GPS location verification and/or utility bill name and address matching for verification specifically for the purpose of writing an Electronic Will. The Electronic Will can be customized and unique to each user for the purpose of planning and executing a legacy plan with the acknowledgment and consent of beneficiaries whom the benefactor wants to be included in that Electronic Will in a public or private setting through a social networking technology application. The security module 144 can operate to verify and record the acknowledgement and consent.

The security module 144 can be configured to implement privacy features such encryption methods implemented to safeguard sensitive information during the verification and will creation processes. The security module 144 can also implement verification algorithms and techniques. The specific unique verification algorithm or technique or technologies used for biometric login, GPS location verification, and utility bill matching can be multi-factor authentication algorithm for our social networking application focused on legacy planning: Dynamic Legacy Verification Algorithm (DLVA):

In embodiments, the DLVA includes a Biometric Login Module that utilizes advanced biometric recognition technologies like facial recognition, voice authentication, and fingerprint scanning. The Biometric Login Module implements a dynamic biometric pattern analysis that adapts over time based on the user's physiological changes.

The DLVA includes Geo-Authentication Module that incorporates a Geo-Verification system that analyzes the user's historical location data and real-time GPS information. The Geo-Authentication module applies machine learning to detect unusual location patterns and trigger additional authentication steps if inconsistencies are detected.

The DLVA includes Utility Bill Matching Module that is an intelligent utility bill matching system that uses optical character recognition (OCR) and pattern recognition to verify the user's identity against their utility bills. The Utility Bill Matching Module employs natural language processing to understand and match the name and address details from the utility bill with the user's profile information.

The DLVA includes Behavioral Analysis Module that integrates a behavioral analysis component that studies the user's interaction patterns within the social networking application. If deviations from the user's typical behavior are detected, the Behavioral Analysis Module can prompt for additional verification steps to ensure the account's integrity.

The DLVA includes a Consent and Acknowledgment Protocol that implements a secure and auditable acknowledgment protocol where beneficiaries can provide consent digitally. The Consent and Acknowledgment Protocol can utilize a blockchain or a distributed ledger system to record beneficiary acknowledgments securely, ensuring the integrity of the acknowledgment trail.

This Dynamic Legacy Verification Algorithm (DLVA) combines various advanced technologies to create a robust and adaptable multi-factor authentication system tailored for legacy planning within a social networking context.

The security module 144 and the documents module 142 can also be configured to implement Blockchain-Secured Electronic Will with Transparent Ledger. The security module 144 and the documents module 142 can securing an Electronic Will in a social networking media application with a transparent, traceable, trustworthy, time-stamped record of a will in personalized newsfeed with automated weekly or monthly emails documenting as a duplicated distributed ledger the decision making and consensus of a benefactor and named beneficiaries declared on a social networking media application in conjunction with blockchain technology mechanisms. The blockchain technology mechanisms can be applied for a tamper-resistant solution of recording information across multiple servers or network of computers across the globe participating in blockchain that makes it extremely difficult for the system to be changed, hacked, or manipulated.

The interface module 140, the documents module 142, the security module 144, and the storage module 144 can generate a Transparent Newsfeed and Email Documentation. In the embodiments, the Electronic Will is presented in a personalized newsfeed, providing transparency and traceability of decision-making and consensus between benefactors and beneficiaries. The interface module 140, the documents module 142, the security module 144, and the storage module 144 can detail the automated weekly or monthly email notifications documenting the changes and decisions made within the Electronic Will, leaving a ledger of transactions across multiple email servers in addition to the platform.

The interface module 140, the documents module 142, the security module 144, and the storage module 144 can implement Blockchain Integration for Tamper-Resistance. The blockchain technology mechanisms applied, such as consensus algorithms and cryptographic methods, ensuring a tamper-resistant solution. The blockchain distributed ledger system is duplicated across multiple servers or computers globally, making it highly secure against manipulation or hacking attempts.

The processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device 104. While FIG. 1 illustrates a single processing device 104, the social media system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the social media system 102 can include multiple memory devices 108, whether the same type or different types.

The communication device 104 enables the social media system 102 to communicate with other devices and systems. The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The social media system 102 can communicate with one or more network resources via the network 116. The one or more network resources 140 can include external databases, social media platforms, search engines, file servers, web servers, or any type of computerized resource that can communicate with the social media system 102 via the network 116. For example, the network resources 140 can include governmental databases of political, legal, and governmental jurisdictions, e.g., states, counties, etc.

In embodiments, the components and functionality of the social media system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the social media system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the social media system 102 and the user device 120 can include a user interface for outputting information in a format perceptible by a user and receiving input from the user. For example, the social media system 102 can communicate with the user interface via the I/O interface 112. In another example, the user device 120 and/or user device 130 can include the user interface for providing information to and receiving information from the user 118 and/or user 128. The user interface can display graphical user interfaces (“GUIs”) generated by the social media system 102 and/or the application 122. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

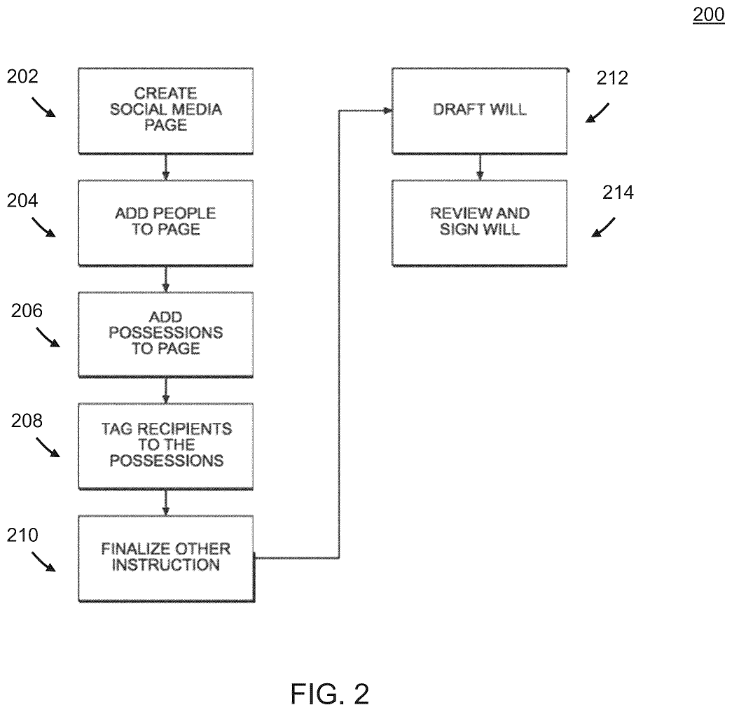

Referring now to FIG. 2, there is shown a flow chart of an example of a method 200 of creating a social media based will. In order to begin the method at least one entity will create a social media profile in stage 202. In different embodiments an entity may be defined differently. In one embodiment an entity is a person. In another embodiment an entity is a trust. In yet a further embodiment an entity is a business or charity.

In order for the best possible results, the more entities that create a social media profile the better. This will allow for more individuals to make wills and be privy to the wills of others. In one embodiment creating a social media profile includes entering an individual's name, a username, and a password. For example, the interface module 140 can generate a GUI to receive the information and the security module 144 can check the information. In other embodiments additional information is required.

For example, in different embodiments individuals may enter their address, a username, a profile picture and other information as needed for a profile. In one embodiment a user may further be able to enter a payment type. This will allow a user to pay for services and upgrade profile types as allowed by the system and described herein. The information can be stored in the databases 114 via the storage module 146.

In one embodiment a user will certify their state of residence. When creating a will this is an important option. Different states have different laws and requirements for a will to be valid. By certifying an individual's state of residence one can ensure that a will is drafted using the proper legal requirements. In a further embodiment a user will enter their relationship status. For example, the user will be able to enter marriage information. In each of these embodiments a person may be able to upload certification documents such as a driver's license or a marriage certificate. To verify this information, the documents module 142 can communicate with the network resources 140 via the network 116 to determine state laws, verify user information, etc.

After the creation of the social media profile, a user may move on to one of two next steps. In one embodiment a user may add people or entities to their contacts list, in stage 204. A contacts list may be a friends list, a relations list or a list of businesses and establishments. Adding people to one's social media profile may take multiple forms. In one embodiment a contact list is a friends list, and anyone can be added to it whether they are members of the social media system or not.

In one embodiment if the person is not a member of the social media system a user must enter contract information as part of adding the individual. In one embodiment the contact information is used to send the person an invite to the social media system. In another embodiment the contact information is stored for use in the event of the user's death and disbursement of the property is needed.

In this embodiment, in stage 206 a user may then add possessions to their social media page. In a second embodiment the order is reversed, and a user adds possessions first and contacts second. In a further embodiment these two steps are continuously done as a user acquires more possessions and more friends, family, or relevant business relationships.

In one embodiment the adding of possessions includes adding physical possessions. In one embodiment in order to add possessions a user will take a picture of the item and upload the photo to their social media profile. In a further embodiment a user will also be able to add additional information such as a make, model, serial number, or other identifying information. In some embodiments an individual's possessions are items of a non-physical nature. For example, a person may upload stock ownership information, bank information, or other assets. In one embodiment an individual may choose an associated photo to represent the item.

After contacts are added and possessions are added, they are assigned to the desired person or company, in stage 208. In one embodiment they are assigned by tagging an individual in the posting of the possession. In this embodiment when one or more individuals or businesses are tagged in a possession post the person will be willed into that possession. In another embodiment, a person may remove a person or business from the will. In this embodiment if a user removes a tag the possession is no longer willed to that party.

In some embodiments additional instructions are added to possessions. In one embodiment an asset will need to be split amongst multiple parties. In another embodiment a party may not be entitled to a possession unless they are of a certain age. In another embodiment an instruction may direct the executor to sell a possession or donate it.

In one embodiment the additional instructions are added directly to the social media posting of the possession, in stage 210. In another embodiment the directions are added to a specific page where an instruction is detailed and associated with the possession. In yet another embodiment the instructions are tagged to the possession.

After possessions are added, people are assigned by being tagged and instructions are developed, and a will is drafted, in stage 212. In one embodiment, one or more machine learning algorithms, e.g., an artificial intelligence program, of the documents module 142 is used to review the social media profile and create a will based on the postings. In another embodiment a will is created after a user hires an attorney to draft the will. In each embodiment the will is drafted using the social media profile.

As part of this step a will may be edited or nullified in favor of a new one. When a will is drafted by the individuals, a profile will be used to ensure the will is in compliance with local laws. Further, in one embodiment, when a person is married, or in a binding relationship, the will is drafted to reflect joint property. In one embodiment when artificial intelligence is used to draft the will or at least monitor the assignment feed the will may include an Exhibit A or other attachment. This attachment will be used to keep track of the possessions and the party assigned to receive the possession. This embodiment will allow for a will to be drafted and signed which dictates how property is to be divided or given. Then, the will may reference the attachment and the attachment can be updated with the possession assignments. This will allow for a user to only need to have the attachment reviewed and signed, or updated. Using this system can save time and money when it comes to constantly updating a will.

After the will is drafted it can be reviewed and signed directly on the social media system, in stage 214. In one embodiment the system will employ a document signature system and send the document to the owner of the social media profile for signature. In this same embodiment the system can also send links to witnesses as necessary. In another embodiment the will must be printed and signed. In this embodiment the social media system will allow for the individual to upload the will for safe keeping.

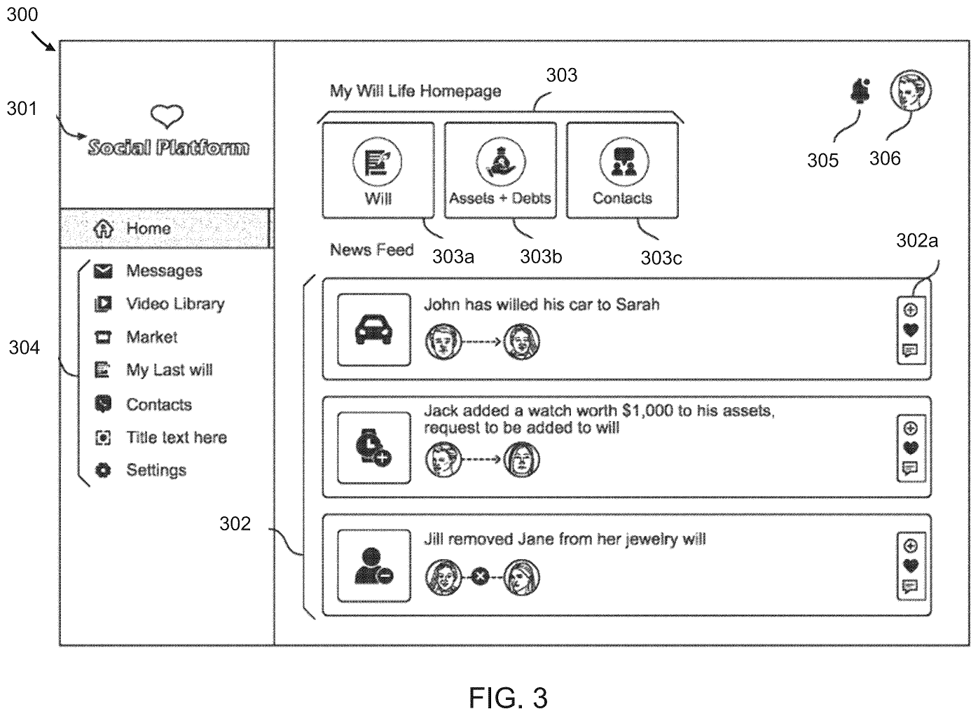

Referring now to FIG. 3, there is shown a perspective view of an embodiment of a social media page used to create a will. In embodiments, the social media page can be generated by the interface module 140. In different embodiments different social media systems may have different aspects and features. In one embodiment a social media system includes at least the following items.

In this embodiment the social media system includes a home page 300. The home page 300 includes a title icon 301. This icon is used to represent the name and company associated with the social media system. The home page 300 is further comprised of a news feed 302. The news feed 302 does not keep track of a person's most recent vacation or status update but of the person's possessions. In one embodiment the news feed 302 will also display the party willed into a possession. In another embodiment the news feed 302 will also display when a party has been removed from a will. In different embodiments the news feed 202 may be made private such that only the owner of the page can see it. In another embodiment the news feed 302 will allow a person to comment on or like a post. In one embodiment there are buttons 302a which will allow for posting or liking of a post.

In one embodiment the social media home page 300 includes several shortcut buttons 303. In one embodiment these shortcut buttons 303 include one to display the most recent will 303a. In another embodiment these shortcut buttons 303 include one to display a user's assets and debts 303b. In yet a further embodiment these shortcut buttons 303 include one to display a user's contacts 303c.

In one embodiment the main social media home page 300 will be linked to many further pages 304. In different embodiments different pages may be linked. In the shown embodiment, the pages include: messages, a video library, a market page, a link to the most recent will, a contacts page, a settings page, or others.

In various embodiments a notification symbol 305 is used to notify a user when they have been tagged. In another embodiment a shortcut button 306 is displayed in order to take a user to their profile page. In other embodiments different buttons may be added to the system.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for social media-based will creation, the method comprises:
receiving user profile information from a user, the user profile information comprising a domicile address;
creating a social media account based on the user profile information, wherein the creating of the social media account verifies the domicile address and the social media account comprises a graphical user interface that displays graphical representations of possession of the user that are viewable by the user and a plurality of second users selected by the user;
receiving identifying information for at least one possession of the user to be added to the social media account;
generating a graphical representation for the at least one possession for the graphical user interface of the social media account;
assigning the at least one possession to at least one second user from the plurality of second users;
updating the graphical representation for the at least one possession to reflect assigning the at least one possession to the at least one second user;
creating a will based on assigning the at least one possession to the at least one second user; and
verifying that the created will is valid and enforceable according to one or more laws of the domicile address.

2. The method of claim 1, the method further comprising:
receiving at least one document as proof of the domicile address;
performing optical character recognition on the at least one document to extract data; and
comparing the data to the user profile information.

3. The method of claim 1, the method further comprising:
receiving geographic location information captured by a user device of the user; and
comparing the geographic location information to the user profile information.

4. The method of claim 1, the method further comprising:
storing the will as a first entry in a distributed cryptographic ledger; and
storing an acknowledgment of the at least one second user as a second entry in the distributed cryptographic ledger.

5. A method for social media based will creation, the method comprises:
receiving user profile information from a user, the user profile information comprising a domicile address of the user and demographic information of the user;
creating a social media account based on the user profile information, wherein the creating of the social media account verifies a user's domicile address and the social media account comprises a graphical user interface that displays graphical representations of a plurality of assets of the user that are viewable by the user and a plurality of second users selected by the user;
receiving identifying information for the plurality of assets of the user to be added to the social media account;
applying the user profile information and the identifying information to one or more machine learning algorithms, wherein the one or more machine learning algorithms have been trained to generate a will using training data comprising demographic information and one or more laws associated with the domicile address; and
automatically creating, by the one or more machine learning algorithms, a will that covers the plurality of assets.

6. The method of claim 5, wherein the one or more machine learning algorithms suggest one or more beneficiaries to be associated with the will based on the demographic information and historical demographic information.

7. The method of claim 5, the method further comprising:
assigning the plurality of assets to at least one of the one or more beneficiaries;
updating the graphical representation for the plurality of assets to reflect assigning the plurality of assets to the at least one of the one or more beneficiaries;
automatically updating the will based on assigning the plurality of assets to the at least one of the one or more beneficiaries.

8. The method of claim 7, the method further comprising:
receiving, via the graphical representations, an acknowledgment of the at least one of the one or more beneficiaries;
storing the will as a first entry in a distributed cryptographic ledger; and
storing an acknowledgment of the at least one of the one or more beneficiaries as a second entry in the distributed cryptographic ledger.

9. The method of claim 5, the method further comprising:
identifying a change in the one or more laws associated with the domicile address;
retraining the one or more machine learning algorithms based on change data associated with the one or more laws; and
updating the will using one or more machine learning algorithms that were retrained.
